(19) United States
(12) Patent Application Publication
(10) Pub. No.: US 2014/0325089 A1
(43) Pub. Date: Oct. 30, 2014

(54) METHOD, TERMINAL, SERVER AND SYSTEM FOR PAGE JUMP

(71) Applicant: Tencent Technology (Shenzhen) Company Limited, Shenzhen (CN)

(72) Inventor: Huashang LIN, Shenzhen (CN)

(73) Assignee: Tencent Technology (Shenzhen) Company Limited, Shenzhen (CN)

(21) Appl. No.: 14/257,946

(22) Filed: Apr. 21, 2014

Related U.S. Application Data
(63) Continuation of application No. PCT/CN2013/087930, filed on Nov. 27, 2013.

(30) Foreign Application Priority Data
Apr. 28, 2013 (CN) 201310156166.8

(51) Int. Cl. H04L 29/12

(52) U.S. Cl. CPC H04L 61/1511
USPC 709/245

(57) ABSTRACT

A method for controlling a page jump includes transferring a jump parameter value for the URL that indicates one or more domain names. The one or more domain names identify domain names a terminal is permitted to navigate to, from the URL. The method also includes receiving a request to navigate from the URL to a second URL; determining whether a domain name of the second URL is included in the one or more domain names indicated by the jump parameter value for the URL; and, in accordance with a determination that the domain name of the second URL is included in the one or more domain names indicated by the jump parameter value, permitting navigation to the second URL.

### RELATED APPLICATIONS

This application is a continuation application of PCT Patent Application No. PCT/CN2013/087930, entitled “METHOD, TERMINAL, SERVER AND SYSTEM FOR PAGE JUMP” filed Nov. 27, 2013, which claims priority to Chinese Patent Application No. 201310156166.8, “METHOD, TERMINAL, SERVER AND SYSTEM FOR PAGE JUMP,” filed Apr. 28, 2013, both of which are hereby incorporated by reference in their entirety.

### FIELD OF THE INVENTION

The present application relates to the field of website safety technology, especially relates to a method, terminal, server and system for page jump.

### BACKGROUND OF THE INVENTION

Uniform Resource Locator (URL), also known as web site, is the standard address of resources on the Internet.

When a user uses a terminal to visit URL A that is an intermediate page used for page jumping, the terminal can automatically jump to URL B in the lead of URL A. For example, when a user is shopping online, after the user submits an order, the terminal can automatically jump from URL A that is used for online shopping to URL B that is used for providing payment functions. However, when a hacker leads the terminal from URL A to URL C used by a phishing website, the user may be led to provide a bank card number, a password and other private information to the phishing website at URL C. In this way, the private information of the user can be stolen, resulting in economic losses for the user. A conventional page jump method attempted to limit illegal page jumping by the following. First, the terminal obtains and analyzes a page content corresponding to a URL that the terminal wants to jump to, and obtains a characteristic value of the page content. Second, the terminal determines whether the characteristic value of the page content matches a preset characteristic value, wherein this preset characteristic value indicates that the page content has a characteristic of a page content provided by a phishing website. Third, if the result is Yes (e.g., the characteristic value of the page content matches the preset characteristic value), the terminal does not display the page content. If the result is No (e.g., the characteristic value of the page content does not match the preset characteristic value), the terminal displays the page content.

However, the conventional method has various problems. For example, in the conventional method, determining whether the page content is provided by a phishing website takes a long time, because it requires analyzing the page content and obtaining the characteristic value of the page content. Because the terminal can determine, only after a very long time, whether to display the page content, web browsing at the terminal is slow.

### SUMMARY

In some embodiments, the invention is implemented in a computer system that has one or more processors, memory and one or more modules, programs or sets of instructions stored in the memory for performing multiple functions. Instructions for performing these functions may be included in a computer program product configured for execution by one or more processors.

One aspect of the invention involves a computer-implemented method for controlling a page jump performed by a computer system having one or more processors and memory. The computer-implemented method includes: transferring a uniform resource locator (URL); transferring a jump parameter value for the URL that indicates one or more domain names, wherein the one or more domain names identify domain names a terminal is permitted to navigate to, from the URL; receiving a request to navigate from the URL to a second URL; determining whether a domain name of the second URL is included in the one or more domain names indicated by the jump parameter value for the URL; and in accordance with a determination that the domain name of the second URL is included in the one or more domain names indicated by the jump parameter value, permitting navigation to the second URL.

Another aspect of the invention involves a computer system. The computer system includes memory, one or more processors, and one or more programs stored in the memory and configured for execution by the one or more processors. The one or more programs include: transferring a uniform resource locator (URL); transferring a jump parameter value for the URL that indicates one or more domain names, wherein the one or more domain names identify domain names a terminal is permitted to navigate to, from the URL; receiving a request to navigate from the URL to a second URL; determining whether a domain name of the second URL is included in the one or more domain names indicated by the jump parameter value for the URL; and in accordance with a determination that the domain name of the second URL is included in the one or more domain names indicated by the jump parameter value, permitting navigation to the second URL.

Another aspect of the invention involves a non-transitory computer readable storage medium having stored therein one or more programs for execution by one or more processors of a computer system, the one or more programs including instructions for: transferring a uniform resource locator (URL); transferring a jump parameter value for the URL that indicates one or more domain names, wherein the one or more domain names identify domain names a terminal is permitted to navigate to, from the URL; receiving a request to navigate from the URL to a second URL; determining whether a domain name of the second URL is included in the one or more domain names indicated by the jump parameter value for the URL; and in accordance with a determination that the domain name of the second URL is included in the one or more domain names indicated by the jump parameter value, permitting navigation to the second URL.

### BRIEF DESCRIPTION OF THE DRAWINGS

The aforementioned features and advantages as well as additional features and advantages thereof are described in more detail below and in the drawings.

FIG. 1 is a structural schematic diagram of implementation environment involved in accordance with some embodiments.

FIG. 2A is a flowchart diagram of a page jump method in accordance with some embodiments.

FIG. 2B is a flowchart diagram of a page jump method in accordance with some embodiments.

FIG. 2C is a flowchart diagram of a page jump method in accordance with some embodiments.

FIG. 3 is a flowchart diagram of a page jump method provided by Embodiment II in accordance with some embodiments.

FIG. 4 is a block diagram of a terminal in accordance with some embodiments.

FIG. 5 is a block diagram of a terminal in accordance with some embodiments.

FIG. 6 is a block diagram of a server in accordance with some embodiments.

FIG. 7 is a block diagram of a server in accordance with some embodiments.

FIG. 8 is a block diagram of a page jump control system in accordance with some embodiments.

FIG. 9 is a block diagram of a computer system for implementing the method of controlling a page jump in accordance with some embodiments.

FIG. 10 is a flow chart of an exemplary method for controlling a page jump in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The embodiments are described in detail below in combination with the attached drawings. Obviously, the embodiments herein describe only certain embodiments and not all possible embodiments. However, based on the embodiments described herein, a person having ordinary skill in the art would understand that variations of these embodiments are possible.

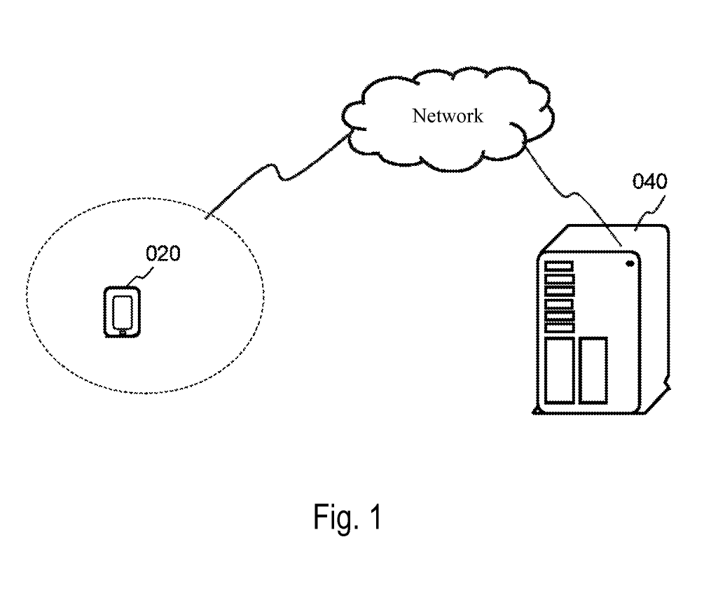

FIG. 1 shows a structural schematic diagram of an implementation environment in accordance with some embodiments. This implementation environment includes terminal 020 and server 040.

In some embodiments, terminal 020 is a terminal containing browsers such as a mobile phone, a tablet, an ebook reader, a desktop and a laptop. Terminal 020 may connect with server 040 through wired network or wireless network so as to realize that terminal 020 sends request to server 040 and the purpose of receiving the processing result that the server feedbacks.

Server 040 can be one or multiple high-performance computers or a cloud computing center connected with terminal 020 through wired network or wireless network. Server 040 can receive and process requests sent by terminal 020 and provide the result of processing to terminal 020.

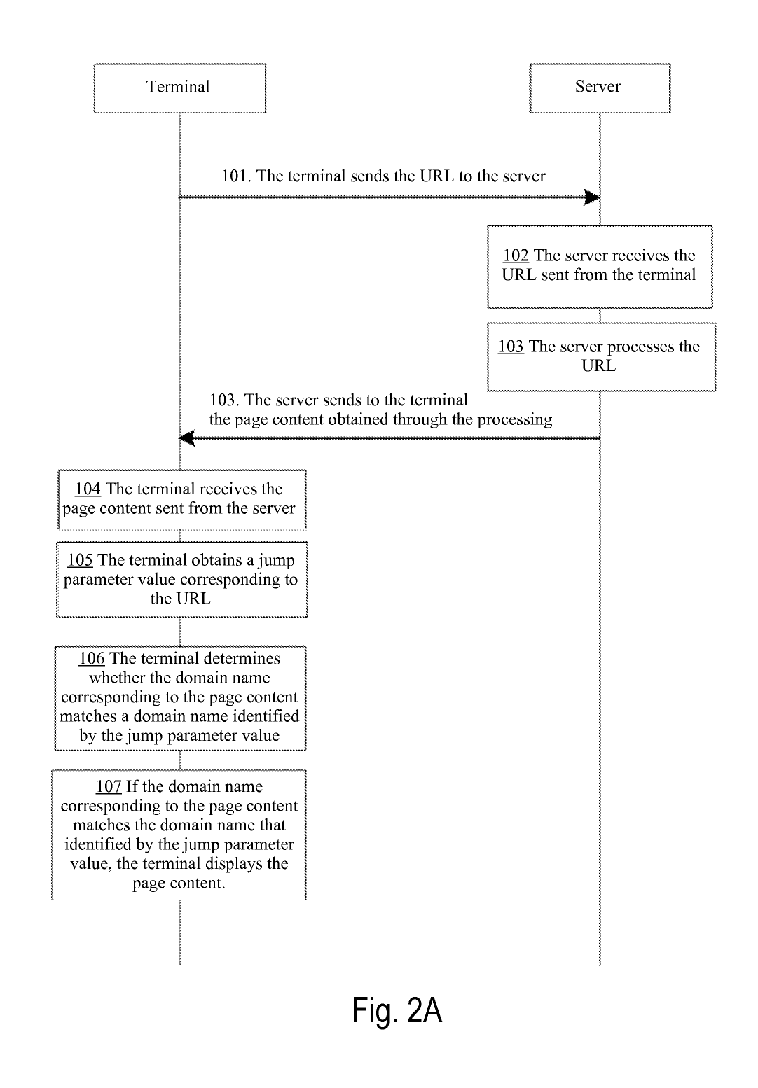

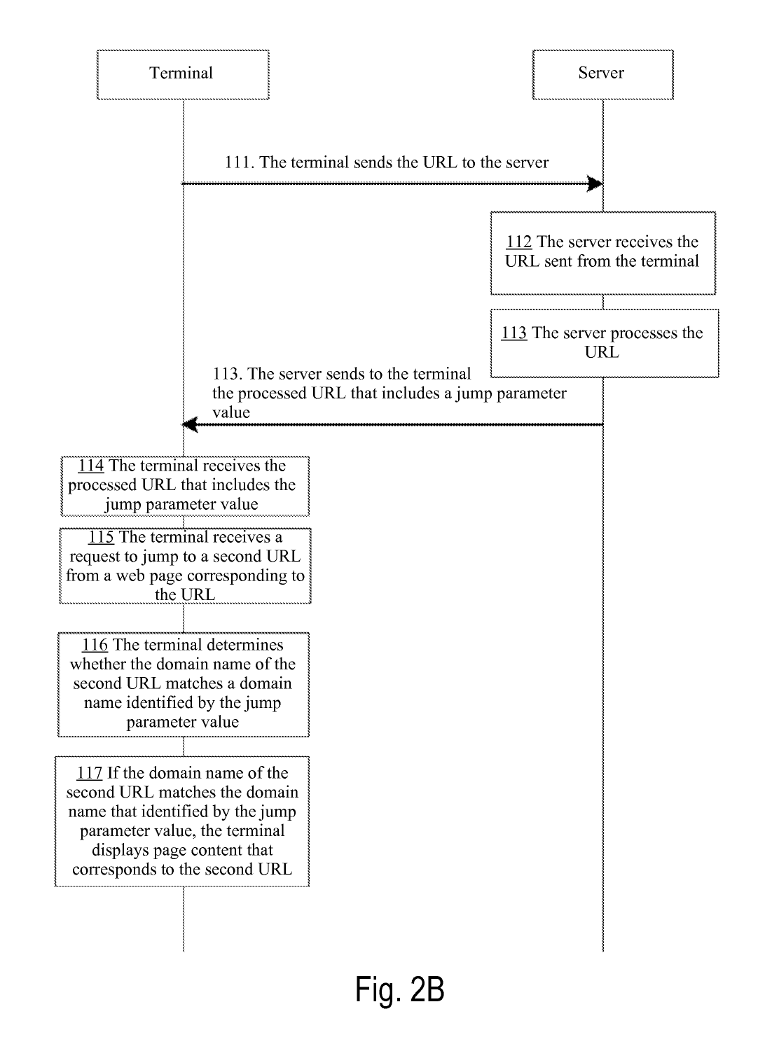

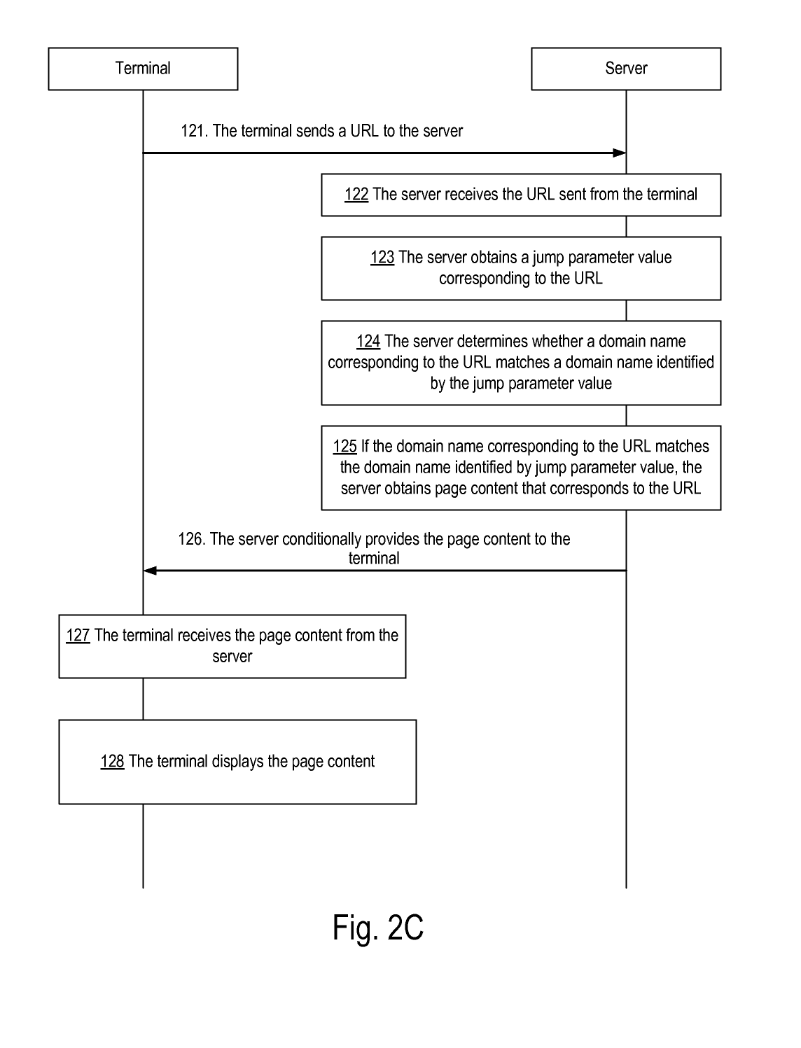

FIG. 2A shows a flowchart diagram of a page jump method in accordance with some embodiments. In some embodiments, the page jump method shown in FIG. 2A is performed in the implementation environment as shown in FIG. 1. The page jump method shown in FIG. 2A includes the following.

In Step 101, the terminal sends a URL to the server.

In Step 102, the server receives the URL sent from the terminal.

In Step 103, the server processes the URL and sends page content to the terminal obtained through processing the URL.

In Step 104, the terminal receives the page content sent from the server.

In Step 105, the terminal obtains a jump parameter value corresponding to the URL.

In some embodiments, the terminal obtains the jump parameter value corresponding to the URL, and the jump parameter value identifies a domain name of an allowed jump destination for the URL.

Although FIG. 2A illustrates that Step 105 is performed after Step 104, FIG. 2A is not meant to be a limiting example. For example, when implemented, Step 105 may be performed before Step 101, Step 102, Step 103 or Step 104. Generally Step 105 needs to be performed before Step 106. However, Step 105 needs not be performed immediately before Step 106.

In Step 106, the terminal determines whether the domain name corresponding to the page content matches the domain name represented by the jump parameter value.

In Step 107, if the determination by the terminal is YES (e.g., the domain name corresponding to the page content matches the domain name identified by the jump parameter value), the terminal displays the page content.

In summary, for the page jump method illustrated in FIG. 2A, the terminal obtains the jump parameter value corresponding to the URL, and, after receiving the page content from the server, determines whether the domain name corresponding to the page content matches the domain name identified by the jump parameter value. If the result of the determination is that the domain name corresponding to the page content matches the domain name identified by the jump parameter value, the terminal will display the page content. This method resolves the problem in the conventional method, which requires a very long time for the terminal to analyze the page content, and as a result, the terminal has been slow to respond to a URL. This method addresses the problem by requiring the terminal to determine whether the domain name corresponding to the page content matches a domain name identified by the jump parameter value, without analyzing the page content, thereby enabling a rapidly response to a URL.

FIG. 2B shows a flowchart diagram of a page jump method in accordance with some embodiments. In some embodiments, the page jump method shown in FIG. 2B is performed in the implementation environment as shown in FIG. 1. The page jump method shown in FIG. 2B includes the following.

In Step 111, the terminal sends a URL to the server. For example, the terminal sends to the server a URL corresponding to a shopping cart page of an online shopping mall.

In Step 112, the server receives the URL sent from the terminal.

In Step 113, the server processes the URL and sends a processed URL. In some embodiments, the server inserts a jump parameter value into the processed URL. For example, the processed URL may include the URL sent from the terminal and the jump parameter value that corresponds to the URL sent from the terminal. In some embodiments, the jump parameter value includes information identifying one or more domain names of web pages, to which the terminal is permitted to jump from the URL sent from the terminal. For example, the jump parameter value may identify the domain names of payment service web pages that are supported by the online shopping mall. In some embodiments, the server stores a plurality of URLs and, for a respective URL of the plurality of URLs, one or more domain names that a terminal is permitted to jump to, from the respective URL. In some embodiments, a first set of one or more domain names for a first URL is distinct from a second set of one or more domain names for a second URL.

In some embodiments, the processed URL has the following structure “scheme://domain_name/path?query_string#fragment_id” (e.g., http://www.onlineshoppingmall.com/gp/product?pf_rd_m=ABCD#123). However, in some other embodiments, the query string (indicated as query string in the above example) or the fragment ID (indicated as fragment_id in the above example) are not included in the processed URL. For example, the processed URL may include a query string without a fragment ID, or the processed URL may include a fragment ID without a query string.

The processed URL includes a jump parameter value. In some embodiments, the jump parameter value is included in the query string of the processed URL. In some embodiments, the jump parameter value is included in the fragment ID of the processed URL. In some embodiments, the jump parameter value is included in yet another portion of the processed URL (e.g., the jump parameter value may be included in the path).

In Step 114, the terminal receives from the server the processed URL that includes the jump parameter value.

In some embodiments, the terminal obtains page content that corresponds to the URL, and displays the page content that corresponds to the URL. For example, the terminal obtains page content of a shopping cart for the online shopping mall, and displays the page content.

In some embodiments, the server initiates obtaining the page content that corresponds to the URL after receiving the processed URL from the server. In some embodiments, the server initiates obtaining the page content that corresponds to the URL after sending the URL to the server and before receiving the processed URL from the server. In some embodiments, the server initiates obtaining the page content that corresponds to the URL before sending the URL to the server. In some embodiments, the server initiates obtaining the page content that corresponds to the URL after receiving a request to jump to a second URL from a web page corresponding to the URL and before determining whether the domain name of the second URL matches a domain name identified by the jump parameter value.

In Step 115, the terminal receives a request to jump to a second URL from a web page corresponding to the URL. For example, a user may press a payment button, in the page content that corresponds to the URL, which initiates obtaining a payment service web page that corresponds to the second URL. The second URL is typically included in the page content that corresponds to the URL (e.g., as a hyperlink). In some embodiments, the request to jump to the second URL is generated without a user input by a script in the web page corresponding to the URL.

In Step 116, the terminal determines whether the domain name of the second URL matches a domain name identified by the jump parameter value. For example, as explained above, in some embodiments, the jump parameter value identifies a domain name that the terminal is permitted to jump to, from the URL. Thus, by determining whether the domain name of the second URL matches a domain name identified by the jump parameter value, the terminal may determine whether the domain name of the second URL matches a domain name that the terminal is permitted to jump to, from the URL.

In Step 107, if the determination by the terminal is YES (e.g., the domain name of the second URL matches the domain name identified by the jump parameter value), the terminal displays page content that corresponds to the second URL.

In some embodiments, if the determination by the terminal is NO (e.g., the domain name of the second URL does not match the domain name identified by the jump parameter value), the terminal foregoes displaying the page content that corresponds to the second URL. Alternatively, if the determination by the terminal is NO, the terminal displays a warning message (e.g., “this page content is from an unauthorized domain”) and the page content that corresponds to the second URL.

FIG. 2C shows a flowchart diagram of a page jump method in accordance with some embodiments. In some embodiments, the page jump method shown in FIG. 2C is performed in the implementation environment as shown in FIG. 1. The page jump method shown in FIG. 2B includes the following.

In Step 121, the terminal sends a URL (e.g., a destination URL). In some embodiments, the terminal sends the URL and a current URL (e.g., a URL of a web page currently displayed by the terminal) to the server. As described herein, the URL is distinct from the current URL.

In Step 122, the server receives the URL sent from the terminal. In some embodiments, the server receives the URL and the current URL from the terminal.

In Step 123, the server obtains a jump parameter value corresponding to the URL (e.g., the URL of the currently displayed web page). As explained above with respect to Step 113 shown in FIG. 2B, in some embodiments, the server stores a plurality of URLs and, for a respective URL of the plurality of URLs, one or more domain names that a terminal is permitted to jump to, from the respective URL (e.g., the URL of the currently displayed web page).

In Step 124, the server determines whether a domain name corresponding to the URL (e.g., the URL of the currently displayed web page) matches a domain name identified by the jump parameter value (e.g., a permitted domain name).

In Step 125, if the domain name corresponding to the URL (e.g., the URL of the currently displayed web page) matches the domain name identified by the jump parameter value (e.g., a permitted domain name), the server obtains page content that corresponds to the URL (e.g., the URL of the currently displayed web page).

In some embodiments, if the domain name corresponding to the URL does not match the domain name identified by the jump parameter value, the server foregoes obtaining page content that corresponds to the URL. Alternatively, in some embodiments, if the domain name corresponding to the URL does not match the domain name identified by the jump parameter value, the server obtains the page content that corresponds to the URL and modifies it by inserting a warning message.

In Step 126, the server conditionally provides the page content to the terminal. For example, in some embodiments, if the domain name corresponding to the URL matches the domain name identified by the jump parameter value, the server sends to the terminal the page content that corresponds to the URL. In some embodiments, if the domain name corresponding to the URL does not match the domain name identified by the jump parameter value, the server sends to the terminal the modified page content that includes the warning message. In some embodiments, if the domain name corresponding to the URL does not match the domain name identified by the jump parameter value, the server foregoes sending to the terminal the page content that corresponds to the URL.

In Step 127, the terminal receives page content from the server (if sent by the server).

In Step 128, the terminal displays the page content (if sent by the server).

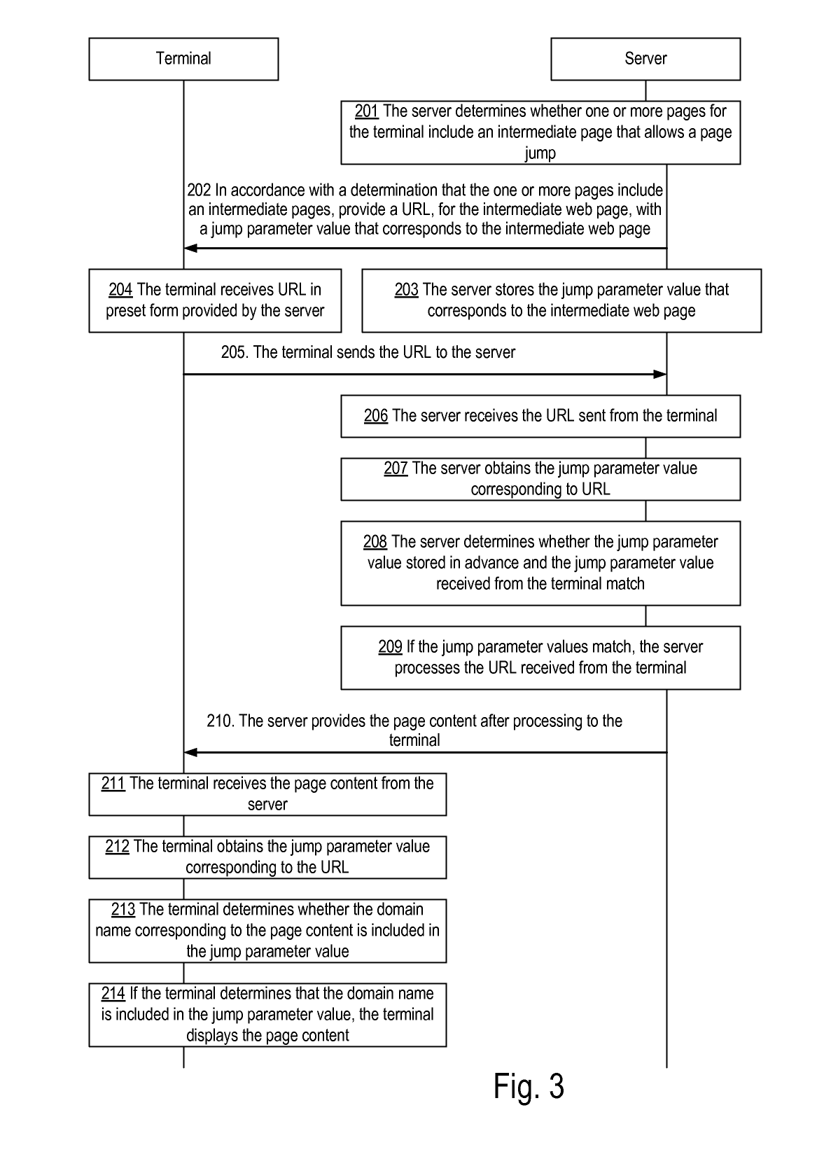

FIG. 3 shows a flowchart diagram of a page jump method in accordance with some embodiments. In some embodiments, the page jump method shown in FIG. 3 is performed in the implementation environment as shown in FIG. 1. The page jump method shown in FIG. 3 includes the following.

In Step 201, the server determines whether one or more pages for the terminal include an intermediate page that allows a page jump. In some embodiments, the server stores information identifying one or more pages for the terminal and identifies whether the one or more pages for the terminal include an intermediate page.

In Step 202, in accordance with a determination that the one or more pages for the terminal include an intermediate page, the server provides a URL, for the intermediate page, with a jump parameter value that corresponds to the intermediate web page. The URL with the jump parameter value includes the jump parameter value in a preset location of the URL (e.g., in a path, a query string, a fragment identifier, etc.). The jump parameter value identifies one or more domain names that the terminal is allowed to jump to, from the URL (or the domain name of the URL).

For example, a server used by a certain shopping website provides a page configured for a user to submit an order, and for the convenience of the user, the server can lead the terminal to jump to a payment web page after the user submits an order. When the server provides a URL for the page configured for the user to submit an order, the server can detect that this page is an intermediate page that needs to jump to another web page, and may limit a domain name that the terminal can jump to, from the web page configured for the user to submit an order. For example, when the server limits the terminal to jump from the page, configured for submitting an order, to pages with domain names of B, C and D and not to pages with any other domain names, the server may set a jump parameter value that identifies B, C and D in a preset location of the URL for the web page configured for submitting an order. In some embodiments, the server sets three jump parameter values that correspond to domain names B, C and D respectively.

For example, the server may set a jump parameter named AllowedJmpDomains in a preset location of URL and set three parameter values of B, C and D for this jump parameter. However, it should be understood that the exemplary jump parameter name is used for illustration purposes only, and a different name may be used. In some embodiments, when the terminal is permitted to jump from an intermediate page to any other page, a domain name in the jump parameter value for the intermediate page may be set to be “any.” In some embodiments, when the terminal is not permitted to jump from an intermediate page when the terminal is not allowed to jump from an intermediate page to any other page, a domain name in the jump parameter value for the intermediate page may be set to be “null.”

In some embodiments, as shown in Step 203, the server stores the jump parameter value that corresponds to the intermediate page. In some embodiments, the server stores the jump parameter value as a list of domain names that the terminal is allowed to jump to from the intermediate page. For example, a list of domain names that the terminal can jump to from a first intermediate page and a list of domain names that the terminal can jump to from a second intermediate page distinct from the first intermediate page may be the same or different. Thus, in some embodiments, the server stores, for respective intermediate pages, a list of domain names that the terminal is allowed to jump to from the respective intermediate pages. In some embodiments, when distinct intermediate pages are associated with distinct Common Gate Way Interface (CGI) names, the server stores, for respective CGI names, a list of domain names that the terminal is allowed to jump to from the distinct intermediate pages (also called herein a list of allowed domain names).

In Step 204, the terminal receives from the server the URL with the jump parameter value. For example, in response to the server providing the URL with the jump parameter value, the terminal receives the URL with the jump parameter value.

In Step 205, the terminal sends the URL with a jump parameter value to the server. In some embodiments, in response to a user request to visit an intermediate page, the terminal sends a URL, which corresponds to the intermediate page, with the jump parameter value.

In Step 206, the server receives the URL, with a jump parameter value, sent from the terminal. In some embodiments, in response to the terminal sending the URL with a jump parameter value, the server receives the URL, with the jump parameter value, sent from the terminal.

In some embodiments, it is possible to limit a page jump without sending or receiving a jump parameter value with a URL. For example, in some embodiments, a terminal sends a URL without the jump parameter value and separately sends information identified by the jump parameter value.

In Step 207, the server obtains the jump parameter value corresponding to the URL. In some embodiments, the server obtains the jump parameter value from the URL that the server receives from the terminal. For example, if the URL that the server receives is “http://baike.xyz.com/view/32614.htm?AllowedJmpDomains=B,C,D”, the server can obtain the jump parameter values of B, C and D from the URL.

In Step 208, the server determines whether the jump parameter value stored in advance (e.g., in Step 203) matches the jump parameter value obtained from the terminal. In order to prevent the jump parameter value received from the terminal has been modified by a hacker to lead the terminal to a phishing website, after the server obtains the jump parameter value received from the terminal, the server obtains the jump parameter value (or a list of allowed domain names) stored in advance, and determines whether the jump parameter value (or the list of allowed domain names) stored in advance matches the jump parameter value received from the terminal. In some embodiments, the jump parameter value stored in advance is deemed to match the jump parameter value received from the terminal if both the jump parameter value stored in advance and the jump parameter value received from the terminal include at least one common domain name.

In Step 209, in accordance with a determination that the jump parameter value stored in advance matches the jump parameter value received from the terminal, the server will process the URL received from the terminal. In some embodiments, when the jump parameter value stored in advance matches the jump parameter value received from the terminal, the server identifies a program, from a server data base, that corresponds to a CGI name in the URL, and executes the identified program.

For example, if domain names in the jump parameter value in the URL received from the terminal are B, C and D and domain names in the stored jump parameter value that correspond to the URL are B, C and D, the server determines that the domain names in the stored jump parameter value include the domain names in the jump parameter value received from the terminal, and starts to process the URL. Certainly, if domain names received from the terminal are B and C and domain names in the stored jump parameter value that correspond to the URL are B, C and D, the server determines that the domain names in the stored jump parameter value include the domain names received from the terminal, and starts to process the URL. However, if the jump parameter value received from the terminal identify domain names “B, C and E” (and domain names in the stored jump parameter value that correspond to the URL are B, C, and D), the server determines that the domain names received from the terminal include a domain name that is not included the stored jump parameter value that corresponds to the URL. In some embodiments, in accordance with a determination that the domain names received from the terminal include a domain name that is not included the stored jump parameter value that corresponds to the URL, the server foregoes processing the URL. In some embodiments, in accordance with the determination that the domain names received from the terminal include a domain name that is not included the stored jump parameter value that corresponds to the URL, the server provides a warning message to the terminal.

In Step 210, the server provides to the terminal page content that corresponds to the URL. Typically, the server obtains the page content that corresponds to the URL prior to providing to the terminal the page content that corresponds to the URL.

In Step 211, the terminal receives the page content from the server.

In Step 212, the terminal obtains the jump parameter value corresponding to the URL.

In order to determine whether the page content is from a domain that the terminal is permitted to jump to, the terminal obtains a jump parameter value that corresponds to the URL. In some embodiments, the terminal obtains the jump parameter value from the URL in a manner similar to those described above.

It should be noted that this step may be performed in a different sequence (e.g., this step may be performed at any step between Step 205 and Step 213).

In some embodiments, as described above, the server identifies one or more domains that the terminal is permitted to jump to. In some embodiments, the terminal performs additional determination whether to display the received page content. For example, after the terminal receives the page content from the server, the terminal determines whether the domain name corresponding to the received page content matches a domain name in the jump parameter value. In accordance with a determination that the domain name corresponding to the received page content matches a domain name in the jump parameter value, the terminal displays the received page content.

In Step 213, the terminal determines whether the domain name corresponding to the page content is included in the jump parameter value.

A hacker may lead the terminal to a page that is provided by a phishing website through a plug-in or other unlawful means. In order to avoid this type of an attack by a hacker, after the terminal receives the page content from the server, the terminal determines whether the domain name corresponding to the page content is a domain name identified by the jump parameter value.

For example, if the domain name corresponding to the page content received from the server is “B” and the jump parameter value that the terminal receives identifies domain names “B”, “C” and “D”, the terminal determines that the domain name “B” is included in the domain names identified by the jump parameter value (e.g., domain names “B”, “C” and “D”). However, if the terminal is led to a page that is provided by a phishing website, the domain name of this page may be “E”. Then the terminal can determine that the domain name corresponding to the page is not identified by the jump parameter value.

In Step 214, if the terminal determines that the domain name of the page content is identified by the jump parameter value, the terminal displays the page content.

In some embodiments, when the terminal determines that the domain name of the page content is identified by the jump parameter value, the terminal indicates that the domain name corresponding to the page content is identified by the jump parameter value and displays the page content. In some embodiments, after displaying the page content, the terminal enters a normal mode. In some embodiments, the terminal in the normal mode displays the page content without a warning message.

In some embodiments, when the terminal determines that the domain name of the page content is not identified by the jump parameter value, it is presumed that the page content is provided by a malicious website. In some embodiments, in accordance with a determination that the domain name of the page content is not identified by the jump parameter value, the terminal displays a warning message. In some embodiments, in accordance with a determination that the domain name of the page content is not identified by the jump parameter value, the terminal foregoes displaying the page content.

In summary, in some embodiments, a jump parameter value corresponding to a URL is obtained and a page content that correspond to the URL is received. It is determined whether the domain name corresponding to the page content is identified by the jump parameter value. If the domain name corresponding to the page content is identified by the jump parameter value, the page content is displayed. This solves the problem that in the conventional method, a terminal needs a very long time to determine whether to display the page content, and as a result, the response speed of the terminal a URL is relatively slow. A faster response is achieved because a terminal needs to determine only whether the domain name corresponding to the page content is included in the page parameter value. In some embodiments, the server determines whether domain names stored in advance include a domain name identified in a jump parameter value received from the terminal, and processes a received URL only when the domain names stored in advance include the domain name identified in the jump parameter value received from the terminal. When the received URL has been modified by a hacker to lead the terminal to a page corresponding to an unauthorized domain name, the server can detect the modification and refuse to process the received URL, thereby intercepting malicious web pages.

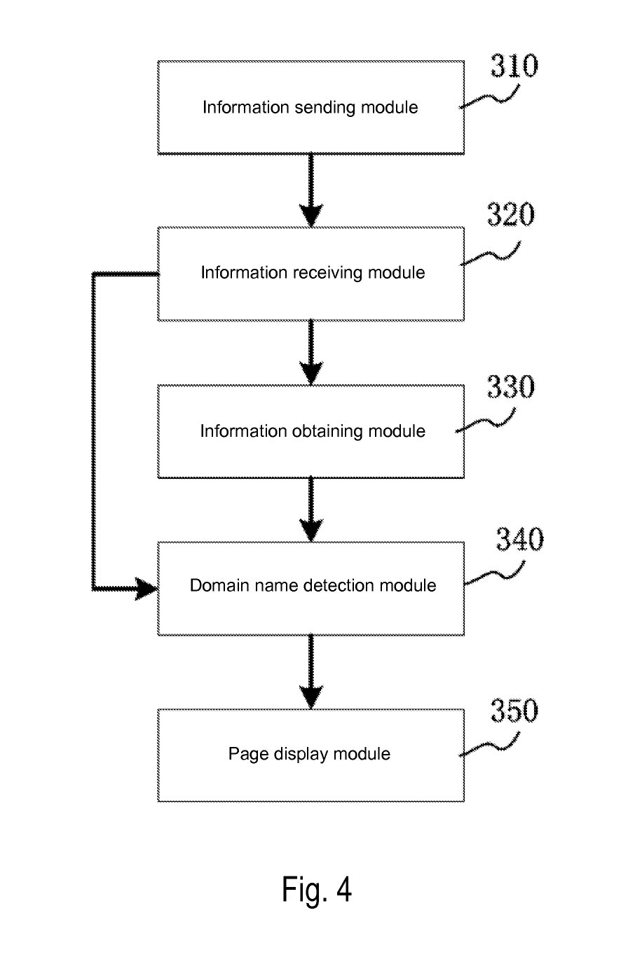

FIG. 4 shows a block diagram of a terminal in accordance with some embodiments. The terminal illustrated in FIG. 4 may be used in the implementation environment shown in FIG. 1. In some embodiments, the terminal includes: an information sending module 310, an information receiving module 320, an information obtaining module 330, a domain name detection module 340, and a page display module 350.

The information sending module 310 is configured to send a URL to a server. In some embodiments, this initiates the server to process the URL and provide corresponding page content.

The information receiving module 320 is configured to receive the page content from the server.

The information obtaining module 330 is configured to obtain a jump parameter value corresponding to the URL. The jump parameter value includes one or more allowed domain names for the URL.

The domain name detection module 340 is configured to determine whether the domain name corresponding to the page content received by the information receiving module 320 is included in the jump parameter value obtained by the information obtaining module 330.

The page display module 350 is configured to display the page content received by the information receiving module 320 if the domain name detection module 340 determines that the domain name corresponding to the page content is included in the jump parameter value.

In summary, in some embodiments, the terminal obtains a jump parameter value corresponding to a URL and receives a page content that correspond to the URL. The terminal determines whether the domain name corresponding to the page content is identified by the jump parameter value. If the domain name corresponding to the page content is identified by the jump parameter value, the terminal displays the page content. This solves the problem that in the conventional method, a terminal needs a very long time to determine whether to display the page content, and as a result, the response speed of the terminal a URL is relatively slow. A faster response is achieved because the terminal needs to determine only whether the domain name corresponding to the page content is included in the page parameter value.

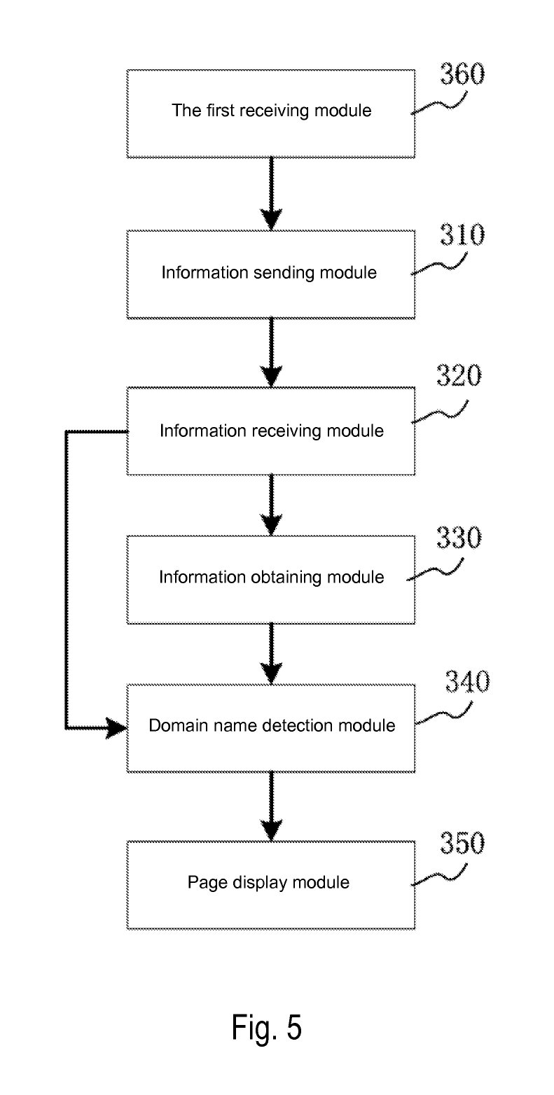

FIG. 5 shows a block diagram of a terminal in accordance with some embodiments. This terminal may be used in the implementation environment shown in FIG. 1. In some embodiments, the terminal includes: the information sending module 310, the information receiving module 320, the information obtaining module 330, the domain name detection module 340 and the page display module 350 as described above with respect to FIG. 4.

In some embodiments, the terminal also includes: a first receiving module 360.

The first receiving module 360 is configured to receive the URL from the server. The URL received from the server includes the jump parameter value.

The information sending module 310 is configured to send the URL that includes the jump parameter value to the server.

In some embodiments, the information obtaining module 330 is configured to obtain a mentioned jump parameter value from the received URL.

In summary, in some embodiments, a jump parameter value corresponding to a URL is obtained and a page content that correspond to the URL is received. It is determined whether the domain name corresponding to the page content is identified by the jump parameter value. If the domain name corresponding to the page content is identified by the jump parameter value, the page content is displayed.

The benefits of these embodiments are similar to the benefits of embodiments described above. For brevity, these details are not repeated.

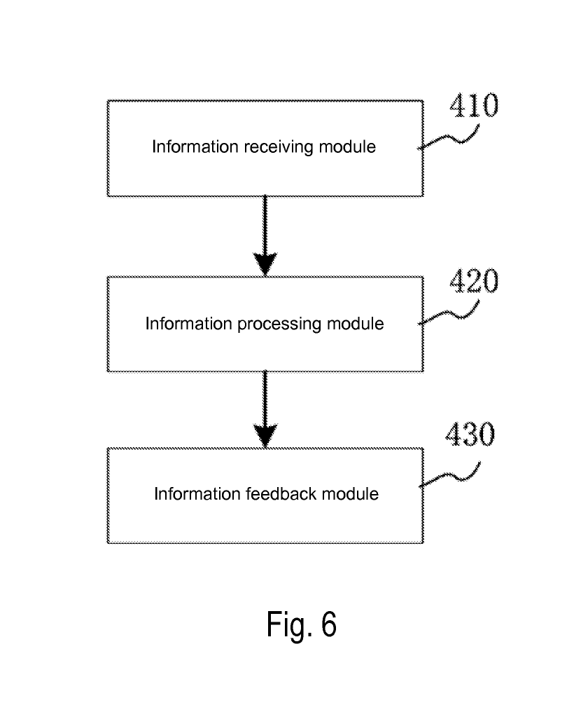

FIG. 6 shows a block diagram of a server in accordance with some embodiments. This server may be used in the implementation environment shown in Figure In some embodiments, the server includes: an information receiving module 410, an information processing module 420 and an information feedback module 430.

The information receiving module 410 is configured to receive a URL from the terminal.

The information processing module 420 is configured to process the URL.

The information feedback module 430 is configured to provide page content that corresponds to the URL to the terminal. In some embodiments, the terminal receives the page content, determines that the domain name corresponding to the page content is included in the jump parameter value, and displays the page content.

In some embodiments, the jump parameter value identifies one or more domain names that the terminal is permitted to jump to, from the URL.

The benefits of these embodiments are similar to the benefits of embodiments described above. For brevity, these details are not repeated.

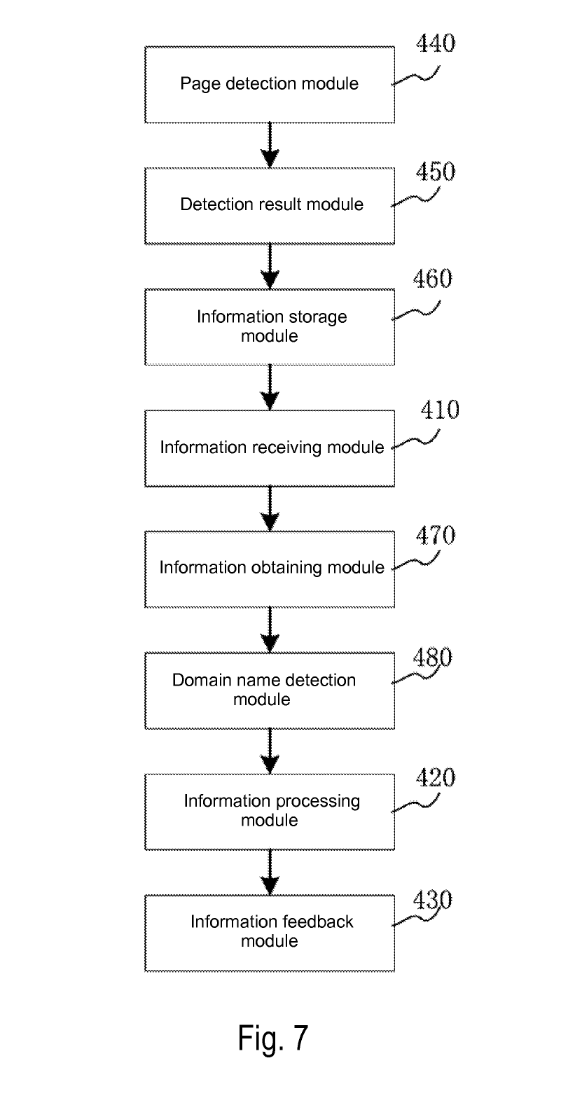

FIG. 7 shows a block diagram of a server in accordance with some embodiments. This server may be used in the implementation environment shown in FIG. 1. In some embodiments, the server includes: the information receiving module 410, the information processing module 420 and the information feedback module 430 as described above with respect to FIG. 6.

In some embodiments, the server also includes: a page detection module 440, a detection result module 450 and an information storage module 460.

The page detection module 440 is configured to detect whether at least one page provided for the terminal includes an intermediate page.

The detection result module 450 is configured to, if page detection module 440 determines that the at least one page provided for the terminal includes an intermediate page, provide the URL in a form that includes the jump parameter value. In some embodiments, the jump parameter value is located at a preset location of the URL.

The information storage module 460 is configured to store one or more domain names, in the jump parameter value, to which the terminal is permitted to jump to, from the URL.

In some embodiments, the server also includes: an information obtaining module 470 and a domain name detection module 480.

In some embodiments, the information obtaining module 470 is configured to obtain the jump parameter value corresponding to the URL.

The domain name detection module 480 is configured to determine whether the one or more stored domain names for the URL contains a domain name included in the jump parameter value obtained by the information obtaining module 470.

The information processing module 420 is configured to, if the domain name detection module 480 determines that the one or more stored domain names contain the domain name included in the jump parameter value, process the URL.

In some embodiments, the information obtaining module 470 is configured to obtain the jump parameter value from a preset location of the URL.

The benefits of these embodiments are similar to the benefits of embodiments described above. For brevity, these details are not repeated.

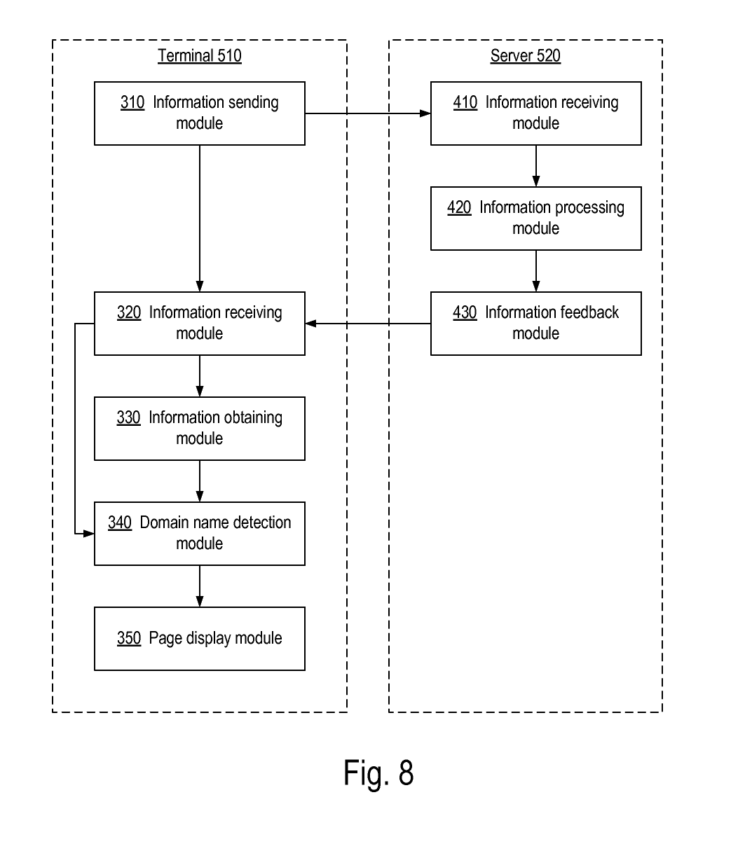

FIG. 8 a block diagram of a page jump control system in accordance with some embodiments. In some embodiments, the system includes terminal 510 and server 520. Certain details of a terminal described above with respect to FIG. 4 and FIG. 5 apply to the terminal 510 shown in FIG. 8. Certain details of a server described above with respect to FIG. 6 and FIG. 7 apply to the server 520 shown in FIG. 8. These details are not repeated herein for brevity.

In summary, in some embodiments, the page jump control system uses a terminal to obtain a jump parameter value corresponding to a URL and receives page content from a server. The terminal detects whether the domain name corresponding to the page content is included in the jump parameter value. If the domain name corresponding to the page content is included in the jump parameter value, the terminal displays the page content.

The benefits of these embodiments are similar to the benefits of embodiments described above. For brevity, these details are not repeated.

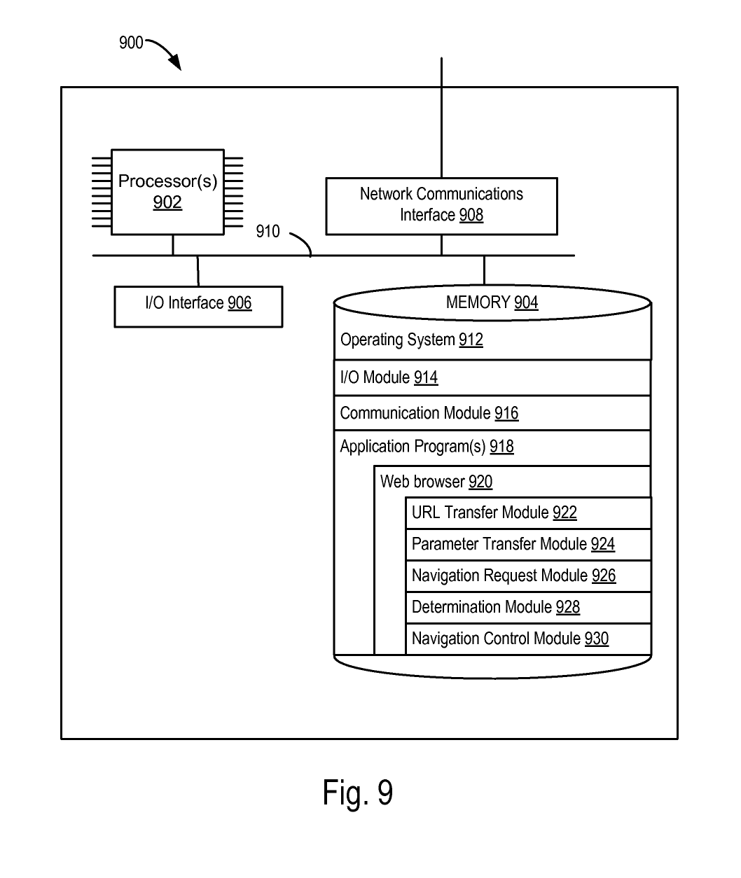

FIG. 9 is a block diagram of a computer system 900 for implementing the method of controlling a page jump in accordance with some embodiments. In some embodiments, the system 900 comprises a terminal (e.g., mobile device, handheld computer, tablet computer, etc.). In some embodiments, the system 900 comprises a server.

As shown in FIG. 9, the system 900 includes one or more processing units (also called herein “processors”) 902, memory 904, an input/output (I/O) interface 906, and a network communications interface 908. These components communicate with one another over one or more communication buses or signal lines 910. In some embodiments, the memory 904, or the computer readable storage media of memory 904, stores programs, modules, instructions, and data structures including all or a subset of: an operating system 912, an I/O module 914, a communication module 916, one or more application programs 918, and an operation control module 924. The one or more processors 902 are coupled to the memory 904 and operable to execute these programs, modules, and instructions, and reads/writes from/to the data structures.

In some embodiments, the processing units 902 include one or more microprocessors, such as a single core or multi-core microprocessor. In some embodiments, the processing units 902 include one or more general purpose processors. In some embodiments, the processing units 902 include one or more special purpose processors.

In some embodiments, the memory 904 includes high-speed random access memory, such as DRAM, SRAM, DDR RAM or other random access solid state memory devices. In some embodiments the memory 904 includes non-volatile memory, such as one or more magnetic disk storage devices, optical disk storage devices, flash memory devices, or other non-volatile solid state storage devices. In some embodiments, the memory 904 includes one or more storage devices remotely located from the processing units 902. The memory 904, or alternately the non-volatile memory device(s) within the memory 904, comprises a computer readable storage medium. In some embodiments, the memory 904 comprises a non-transitory computer readable storage medium.

In some embodiments, the I/O interface 906 couples one or more input/output devices, such as one or more displays (e.g., a touch-sensitive display, also called a touch screen), a keyboards, touch screens, speakers, and microphones, to the I/O module 914 of the system 900. The I/O interface 906, in conjunction with the I/O module 914, receive user inputs (e.g., voice input, keyboard inputs, touch inputs, etc.) and process them accordingly. The I/O interface 906 and the I/O module 914 also present outputs (e.g., sounds, images, text, etc.) to the user according to various program instructions implemented on the system 900.

In some embodiments, the network communications interface 908 includes wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends RF signals and/or optical signals from/to communications networks and other communications devices. The wireless communications may use any of a plurality of communications standards, protocols and technologies, such as GSM, EDGE, CDMA, TDMA, Bluetooth, WiFi, VoIP, Wi-MAX, or any other suitable communication protocol. The network communications interface 908 enables communication between the system 900 with networks, such as the Internet, an intranet and/or a wireless network, such as a cellular telephone network, a wireless local area network (LAN) and/or a metropolitan area network (MAN), and other devices. The communications module 916 facilitates communications between the system 900 and other devices (e.g., the first client device and the second client device) over the network communications interface 908.

In some embodiments, the operating system 902 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

In some embodiments, the system 900 is implemented on a portable electronic device (e.g., a smart phone, a mobile phone, a tablet computer, etc.). It should be noted that the system 900 is only one example, and that the system 900 may have more or fewer components than shown, may combine two or more components, or may have a different configuration or arrangement of the components. The various components shown in FIG. 9 may be implemented in hardware, software, firmware, including one or more signal processing and/or application specific integrated circuits, or a combination of thereof.

In FIG. 9, the one or more application programs 918 stored in the memory 904 include a web browser 920. A web browser, when stored in a terminal or a client device, typically refers to an application program that processes page content of a web page and initiates a display of the page content on a display of the system 900. When stored in a server, a web browser typically refers to a server application that obtains and provides page content of a web page to a terminal.

As shown in FIG. 9, in some embodiments, the web browser 920 includes the followings modules, or a subset or superset thereof: a URL transfer module 922, a parameter transfer module 924, a navigation request module 926, a determination module 928, and a navigation control module 930.

In some embodiments, the URL transfer module 922 is configured to transfer a URL (e.g., between a terminal and a server).

In some embodiments, the parameter transfer module 924 is configured to transfer a jump parameter value (e.g., between a terminal and a server).

In some embodiments, the navigation request module 926 is configured to receive a request to navigate to a target URL.

In some embodiments, the determination module 928 is configured to determine whether a domain name of the target URL is an authorized domain name.

In some embodiments, the navigation control module 930 is configured to conditionally permit navigation to the target domain name.

Details on the structures, functions, and interactions of these modules are provided with respect to FIGS. 1, 2A-2C, 3-8, and 10 and accompanying descriptions.

It should be noted that in the device for controlling a page jump provided in the abovementioned embodiments, illustration is only made by way of example according to the division of the above-mentioned functional modules, and in practical application, the above-mentioned functions can be assigned to be completed by different functional modules as required, i.e., dividing the internal structure of the device into different functional modules to complete all or some of the above-described functions.

In addition, the device for controlling a page jump and the method for controlling a page jump provided by the embodiments described herein belong to the same concept, and its specific implementation process can be seen in the method embodiment, which will not be repeated here for brevity.

The sequence numbers of the embodiments described herein are merely for description purposes, and do not represent the advantages or disadvantages of the embodiments.

Those skilled in the art can understand that all or part of the steps of the embodiments described herein can be implemented by hardware, and can also be implemented by a program instructing relevant hardware, and the program can be stored on a computer readable storage medium, and the abovementioned storage medium can be a random access memory, a magnetic disk, or an optical disk, and so on.

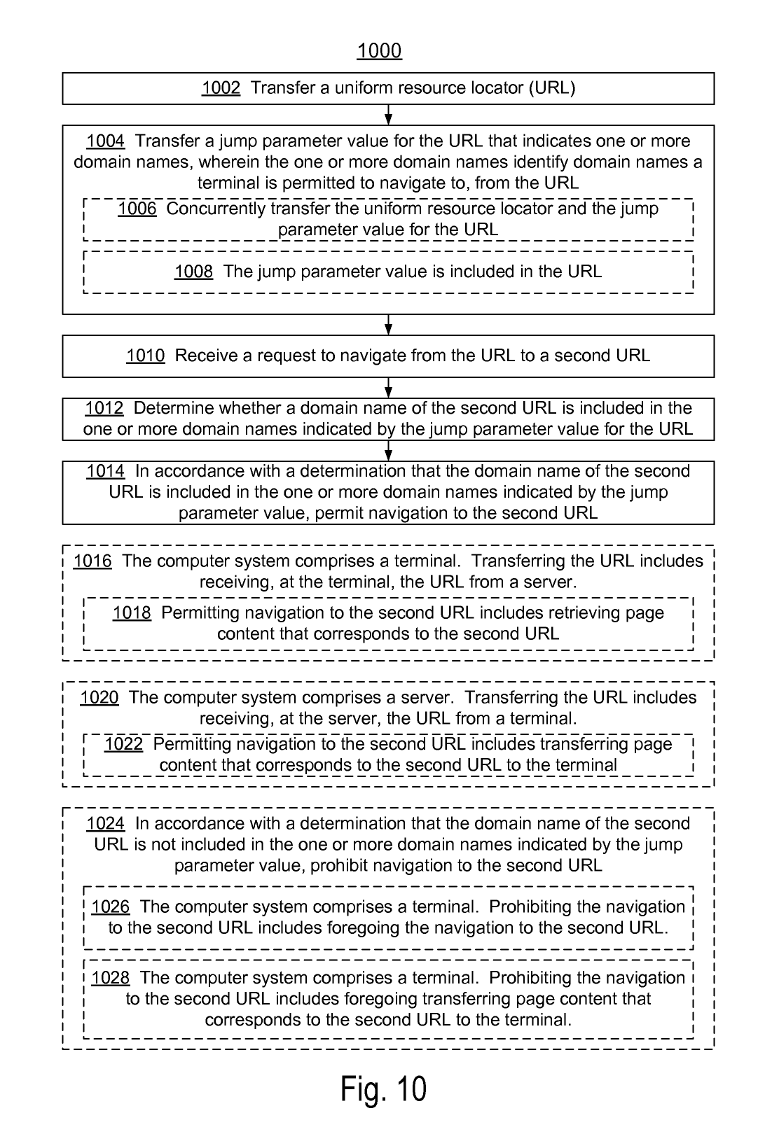

FIG. 10 is a flow chart of an exemplary method 1000 for controlling a page jump in accordance with some embodiments. The method is performed by a computer system (e.g., the computer system 900 illustrated in FIG. 9) with memory and one or more processors.

The computer system transfers (1002) a uniform resource locator (URL). For example, a terminal receives the URL from a server (e.g., in response to sending a request to navigate to the URL to the server). An exemplary URL received from the server corresponds to domain name A.

The computer system transfers (1004) a jump parameter value for the URL that indicates one or more domain names. The one or more domain names identify domain names a terminal is permitted to navigate to, from the URL. For example, the jump parameter value may indicate that the terminal is permitted to navigate from the domain name A to domain names B, C, and D.

In some embodiments, the computer system concurrently transfers (1006) the uniform resource locator and the jump parameter value for the URL. For example, the terminal may receive both the URL and the jump parameter value for the URL in a single communication.

In some embodiments, the jump parameter value is included (1008) in the URL. For example, the jump parameter value may be included in the URL as a path, a query string, or a format ID. In some embodiments, the jump parameter value is included in a query string of the URL. In some embodiments, the jump parameter value is included in a path of the URL.

The computer system receives (1010) a request to navigate from the URL to a second URL. For example, the terminal may receive a user input that corresponds to a request to navigate to another web page (e.g., a mouse click on a text associated with a hyperlink).

The computer system determines (1012) whether a domain name of the second URL is included in the one or more domain names indicated by the jump parameter value for the URL. In some embodiments, the computer system determines whether the domain name of the second URL is included in the one or more domain names indicated by the jump parameter value for the URL, in response to the request to navigate from the URL to the second URL. For example, when the terminal has received a request to navigate to a second URL that corresponds to domain name B, the terminal may determine whether domain names B, C, and D identified in the jump parameter value include domain name B.

The computer system, in accordance with a determination that the domain name of the second URL is included in the one or more domain names indicated by the jump parameter value, permits (1014) navigation to the second URL. For example, when the jump parameter value identifies domain names B, C, and D, and the terminal has received a request to navigate to a second URL that corresponds to domain name B, the terminal permits navigation to the second URL.

In some embodiments, the computer system comprises (1016) a terminal. Transferring the URL includes receiving, at the terminal, the URL from a server.

In some embodiments, permitting navigation to the second URL includes (1018) retrieving page content that corresponds to the second URL. For example, the terminal retrieves page content that corresponds to the second URL (e.g., using a web browser).

In some embodiments, the computer system comprises (1020) a server. Transferring the URL includes receiving, at the server, the URL from a terminal.

In some embodiments, permitting navigation to the second URL includes (1022) transferring page content that corresponds to the second URL to the terminal. For example, when the method is implemented in the server, the server retrieves page content that corresponds to the second URL and provides the page content to the terminal.

In some embodiments, in accordance with a determination that the domain name of the second URL is not included in the one or more domain names indicated by the jump parameter value, the computer system prohibits (1024) navigation to the second URL. For example, when the jump parameter value identifies domain names B, C, and D, and the terminal has received a request to navigate to a second URL that corresponds to domain name E, the terminal prohibits navigation to the second URL.

In some embodiments, the computer system (1026) comprises a terminal, and prohibiting the navigation to the second URL includes foregoing the navigation to the second URL. For example, when the jump parameter value identifies domain names B, C, and D, and the terminal has received a request to navigate to a second URL that corresponds to domain name E, the terminal does not navigate to the second URL. In some embodiments, prohibiting the navigation to the second URL includes displaying a warning message.

In some embodiments, the computer system comprises (1028) a server, and prohibiting the navigation to the second URL includes foregoing transferring page content that corresponds to the second URL to the terminal. For example, when the jump parameter value identifies domain names B, C, and D, and the server has received a request to navigate to a second URL that corresponds to domain name E, the server does not transfer, to the terminal, page content that corresponds to the second URL.

It shall be noted that the modules described herein are only examples. A person having ordinary skill in the art would understand that, in actual implementation, the aforementioned functions may be performed by different functional modules or different groups of functional modules. In addition, some of the methods described herein are performed by a terminal or a server described herein. Thus, a person having ordinary skill in the art would understand the method by also referring to the description of the terminal and/or the server described herein. For brevity, these details are not repeated.

While particular embodiments are described above, it will be understood these embodiments are not intended to limit the scope of claims to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for controlling a page jump, performed by a computer system with memory and one or more processors, the method comprising:
transferring a uniform resource locator (URL);
transferring a jump parameter value for the URL that indicates one or more domain names, wherein the one or more domain names identify domain names a terminal is permitted to navigate to, from the URL;
receiving a request to navigate from the URL to a second URL;
determining whether a domain name of the second URL is included in the one or more domain names indicated by the jump parameter value for the URL; and,
in accordance with a determination that the domain name of the second URL is included in the one or more domain names indicated by the jump parameter value, permitting navigation to the second URL.

2. The method of claim 1, wherein the computer system comprises a terminal, and transferring the URL includes receiving, at the terminal, the URL from a server.

3. The method of claim 2, wherein permitting navigation to the second URL includes retrieving page content that corresponds to the second URL.

4. The method of claim 1, wherein the computer system comprises a server, and transferring the URL includes receiving, at the server, the URL from a terminal.

5. The method of claim 4, wherein permitting navigation to the second URL includes transferring page content that corresponds to the second URL to the terminal.

6. The method of claim 1, further comprising:
in accordance with a determination that the domain name of the second URL is not included in the one or more domain names indicated by the jump parameter value, prohibiting navigation to the second URL.

7. The method of claim 1, wherein the computer system comprises a terminal, and prohibiting the navigation to the second URL includes foregoing the navigation to the second URL.

8. The method of claim 1, wherein the computer system comprises a server, and prohibiting the navigation to the second URL includes foregoing transferring page content that corresponds to the second URL to the terminal.

9. The method of claim 1, including concurrently transferring the uniform resource locator and the jump parameter value for the URL.

10. The method of claim 1, wherein the jump parameter value is included in the URL.

11. A computer system for controlling a page jump, comprising:
one or more processors; and
memory storing one or more programs for execution by the one or more processors, the one or more programs including instructions for:
transferring a uniform resource locator (URL);
transferring a jump parameter value for the URL that indicates one or more domain names, wherein the one or more domain names identify domain names a terminal is permitted to navigate to, from the URL;
receiving a request to navigate from the URL to a second URL;
determining whether a domain name of the second URL is included in the one or more domain names indicated by the jump parameter value for the URL; and,
in accordance with a determination that the domain name of the second URL is included in the one or more domain names indicated by the jump parameter value, permitting navigation to the second URL.

12. The computer system of claim 11, wherein the computer system comprises a terminal.

13. The computer system of claim 11, wherein the computer system comprises a server.

14. The computer system of claim 11, wherein the one or more programs include instructions for:
in accordance with a determination that the domain name of the second URL is not included in the one or more domain names indicated by the jump parameter value, prohibiting navigation to the second URL.

15. The computer system of claim 11, wherein the jump parameter value is included in the URL.

16. A non-transitory computer readable storage medium storing one or more programs for execution by one or more processors of a computer system, the one or more programs including instructions for:
transferring a uniform resource locator (URL);
transferring a jump parameter value for the URL that indicates one or more domain names, wherein the one or more domain names identify domain names a terminal is permitted to navigate to, from the URL;
receiving a request to navigate from the URL to a second URL;
determining whether a domain name of the second URL is included in the one or more domain names indicated by the jump parameter value for the URL; and,
in accordance with a determination that the domain name of the second URL is included in the one or more domain names indicated by the jump parameter value, permitting navigation to the second URL.

17. The computer readable storage medium of claim 16, wherein the computer system comprises a terminal.

18. The computer readable storage medium of claim 16, wherein the computer system comprises a server.

19. The computer readable storage medium of claim 16, wherein the one or more programs include instructions for:
in accordance with a determination that the domain name of the second URL is not included in the one or more domain names indicated by the jump parameter value, prohibiting navigation to the second URL.

20. The computer readable storage medium of claim 16, wherein the jump parameter value is included in the URL.
